(19) United States
(12) Patent Application Publication
(10) Pub. No.: US 2009/0035539 A1
(43) Pub. Date: Feb. 5, 2009

(54) PIRACY PROTECTED RECORDING MEDIA

(75) Inventor: Richard H. Selinfreund, Terre Haute, IN (US)

Correspondence Address: KELLEY DRYE & WARREN LLP, 400 ALTLANTIC STREET , 13TH FLOOR, STAMFORD, CT, 06901, US

(73) Assignee: VERIFICATION TECHNOLOGIES, INC., Essex, CT (US)

(21) Appl. No.: 12/250,996

(22) Filed: Oct. 14, 2008

Related U.S. Application Data
(63) Continuation of application No. 11/404,980, filed on Apr. 14, 2006.
(60) Provisional application No. 60/672,265, filed on Apr. 18, 2005.
(60) Provisional application No. 60/673,456, filed on Apr. 21, 2005.
(60) Provisional application No. 60/715,071, filed on Sep. 8, 2005.

(51) Int. Cl. B32B 3/10

(52) U.S. Cl. 428/201

(57) ABSTRACT

An optical medium piracy system employing a state-change material in association with a digital data indicia, wherein when state-change material is activated to change state, the optical medium moves from an unreadable to a readable condition, or from a less readable to more readable condition.

### CROSS-REFERENCE TO RELATED APPLICATIONS

This application is a continuation application of U.S. patent application Ser. No. 11/404,980, filed Apr. 14, 2006, which claims priority to U.S. Provisional Patent Application Nos. 60/672,265 filed Apr. 18, 2005, 60/673,456 filed Apr. 21, 2005, and 60/715,071, filed Sep. 8, 2005. The disclosures of each such application are hereby incorporated by reference in their entirety where appropriate for teachings of additional or alternative details, features, and/or technical background, and priority is asserted from each.

### BACKGROUND OF THE INVENTION

1. Field of the Invention

The present invention generally relates to the protection of transportable media storing information readable by a reader from piracy anywhere along the distribution chain.

2. Description of the Related Art

The development of software and other forms of content data, such as visual and auditory digital data, represents a large investment in time and money. Such content data is generally stored in digital form on a transportable storage medium which is then sold to a purchaser. Unfortunately, with most traditional transportable recording media, extraction of the data from the transportable storage media is possible anywhere in its distribution chain. Furthermore, given the transportability of the recording media, clandestine movement of the media from the distribution chain is generally easy.

Transportable recording media are particularly prone to shoplifting and intra-distribution chain theft. Shoplifting in sales outlets, and thefts in the distribution chain, are significant problems adversely affecting both sellers and consumers. It is estimated that with respect to shoplifting of all merchandise, retail sellers lose between $10 and $12 billion annually and spend an additional $7 to $10 billion on anti-shoplifting measures, including security devices and personnel to prevent shoplifting. To offset the costs of shoplifting and distribution chain theft, sellers pass these costs on to consumers in the form of higher prices on merchandise. It is estimated that each household in the United States pays retail sellers approximately $200 per year in increased retail prices for merchandise due to the costs of shoplifting alone.

It is not uncommon to have losses in the supply chain due to unauthorized removal of products. The percent losses in some areas may reach as high as thirty percent.

There have been numerous attempts to curb content data piracy on transportable recording media. In one approach, a serial number is placed in the content data to allow for tracing of unauthorized copies of the serialized content data. The problem with this method is that it requires the task of external enforcement to track down illegal copies and is relatively of little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable recording media, such transponder tags are typically associated with the packaging surrounding the media. EAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable recording media is often small and easily concealed, EAS systems are easily overcome by simply removing the desired recording medium from its packaging, concealing the medium and then concealingly removing the medium. After the media is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

There is needed, therefore, an improved technique for reducing the theft of transportable digital recording media, and the content of such transportable digital recording media.

### DEFINITIONS

“Digital Datum Indicium”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

“Digital Reader”: any device capable of detecting and reading digital information that has been recorded on a Digital Recording Medium.

“Digital Recording Medium”: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, audio files and video files.

“Light-Activated State-Change Material” is a State-Change Material that alters a measurable state function upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable state function upon application of energy to the material, stays in such state permanently or for a prolonged period of time.

“Rapid State-Change Material”: a State-Change Material that changes upon activation by an activation source in less than 1 minute from a first state to a second state, both states being discernible by a reader.

“Reader”: A device for reading data on a recording medium. By the term “reader” it is meant to include, without limitation, a player. Examples are CD and DVD readers.

“Sound-Activated State-Change Material”: a State-Change Material that alters a measurable property of the material upon application of sound energy to the material.

“State-Change Material”: a material capable of altering a measurable property of the material upon activation of the material by application of energy to the material. By “state-change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy.

“Transportable Digital Recording Medium”: a relatively small medium capable of being transported by hand from one location to another. It includes, without limitation, an optical disc, a floppy disk, a flash drive.

For the purpose of the rest of the disclosure, it is understood that the terms as defined above are intended, whether such terms are in all initial cap or not.

### SUMMARY OF THE INVENTION

The present invention provides for a piracy protected transportable recording medium that is readable on a reader. In a particular embodiment, there is provided a piracy protectable transportable digital recording medium that is readable on a digital reader.

In an embodiment, such transportable recording medium has incorporated thereon a state-change material in association with data indicia on the medium in a manner such that the read of the data indicia is altered when said state-change material is activated. The state-change is induced at a point in the distribution chain desired, such as at sale, such that the recording medium moves from an unreadable or semi-readable state to a fully or more readable state by a reader. The state-change material may be a rapid state-change material such that activation times are, for example, less than 50 seconds, less than 30 seconds, less than 15 seconds, less than 10 seconds.

In an embodiment, the transportable recording medium is protected against theft, or illicitly moving the recording medium in and out of the distribution chain, in that the medium is not readable, or fully readable, until the state-change material is activated to the state necessary for such a read. Activation of the state-change material may be by light, sound, chemical reaction, or any mechanism that provides energy to the state-change material, changes its conformational or configuration states, or provides for a new chemical entity to be produced upon activation.

When the transportable recording medium is a transportable digital recording medium, in one embodiment one or more of the digital data indicia associated with the state-change material may be non-nominal, causing the transportable digital recording medium to be unreadable, or unreadable with respect to certain information. The state-change material may be selected such that when the state-change material is activated, the non-nominal indicia associated with the material no longer blocks the read of the digital data on the medium.

### DETAILED DESCRIPTION OF THE INVENTION

The present invention provides for the protection of transportable media storing information from piracy anywhere along the distribution chain.

Protection is provided by allowing the data read of the recording medium to be changed at will by application of a the appropriate energy source from a limited data read to a more full data read. Application of the appropriate energy source changes the state of a state-change material in a manner to change the data read. The state-change material is associated with data indicia in such a manner that upon change of the state of the material, the data read with data indicia is changed. The state-change material may be, among other material types, a temporary state-change material, a transient state-change material, a light-activated state-change material, and/or a sound-activated state change material.

External activation of the state-change material may be by any energy source that causes a measurable state change that is readable by a reader and causes the data indicia to which it is associated to change read or read status (e.g., unreadable to readable).

In an embodiment pertaining to a digital recording medium, the read of one or more digital data indicia is changed by activation of the state-change material to a different state (e.g., a change in optical state in respect of an optical recording medium, or a change in electromagnetic state in respect of an electromagnetic recording medium). One or more digital data indicia may be associated with the state-change material. Such association may be selective, such as the state-change material being associated with only some of the digital data indicia on the digital recording medium, or the state-change material may be associated with the majority, all, or substantially all, of the digital data indicia, and a read change is effectuated only with respect to certain indicia based, for example, on differences between these special indicia or differences in the milieu in association with such special indicia (e.g., a compound existing or missing in the area of the special indicia as compared to the digital data indicia of the recording medium as a whole). The read of these special data read indicia is effected by the activation change, and these indicia may be pits and/or lands representative of data incorporated onto an optical recording medium, or other digital data indicia such as electromagnetic aberrations on an electromagnetic recording medium.

In an embodiment, there is disclosed a piracy-protected recording medium comprising: a data portion comprising indicia readable by a recording medium reader as data, and a state-change material in association with at least a part of the data portion, wherein the state-change material is operationally configured to interfere with the read by the reader of the data portion of the recording medium when in a first unactivated state but permits enhanced read by the reader of the data portion when in a second activated state.

In a particular digital recording medium embodiment, the state-change material is associated with one or more digital datum indicium that is not a nominal digital datum indicium for the recording medium. For example, the non-nominal digital datum indicium may be a pit and/or land that is not nominal (standard) for the optical disc format. The non-nominal digital datum indicium in such embodiment causes, for example by way of the error correction algorithms associated with the medium or by way of software or firmware associated with the medium or reader, the disc to be unreadable in whole or in part. The state-change material associated with such non-nominal digital datum indicium may be selected to cause a change in the read of such non-nominal digital datum indicium-blocking read (in whole or in part) when the state-change material is in one state but permitting read (in whole or in part) when the state-change material is in another state. The state change may, for example, allow data previously hidden from the reader to be read by the reader or may result in a read that permits correction by the error correction algorithm, whereas the state-change material in the unactivated state does not permit correction by the error correction algorithm(s). The non-nominal digital datum indicium may represent or cause an error read or valid read. For example, when the non-nominal digital datum indicium represents or causes an error read, the state-change material in association therewith may be chosen to produce a valid read or a different error state that is necessary for the read of the optical medium as a whole. On the other hand, for example, when the non-nominal digital datum indicium represents or causes a valid data read, the state-change material may be chosen to cause, when activated, either another valid state or an error state necessary for the read of the medium in general. The read of the medium as a whole may be under the control of a software program stored on the medium, in the hardware of the reader, in hardware or software associated with the reader, or may be a function of the error correction algorithms associated with the particular medium being read (such as optical disc correction algorithms).

In yet another embodiment, the recording medium is engineered to be unplayable in an initial state, or the amount of digital information readable from the medium by a reader is limited. Activation of the state-change material is necessary for read or fuller read of the medium.

In a digital recording medium embodiment, there may be found unique pits and/or lands in the presence of the optical state-change material that would induce an uncorrectable error state in the read of the medium. When the state-change material is activated by the appropriate energy source, for example, without limitation, such as by light or sound, the read of the unique pits or lands may be changed to cause the uncorrectable error state to change to a valid state permitting the medium to be read.

The digital datum indicium causing the digital recording medium not to be read might also be a valid state which might provide an ambiguous or non-ambiguous read that because of one or more algorithms associated with the reader or disc prohibits the read of the digital recording medium (or a portion of the digital reading medium). Activation of the state-change material could cause such valid state to convert to another valid state or to an error state that is necessary, for example, because of algorithms associated with the reader system or medium or firmware/hardware setup, for the full read/fuller read of the medium (or portion of the medium). Similarly, although the digital datum indicium may be an error state with read effectuated, owing to such algorithms or firmware/hardware set up, only when another error state or a valid state is produced upon activation of the state-change material.

In one digital data recording medium embodiment, the digital data recording medium comprises digital data indicia that cause an error data read that prohibits the medium from being read, or a portion of the medium to be read. When the recording medium is exposed to the appropriate energy source for converting the state-change material, the data read is changed to a valid state allowing for the read of the recording medium.

In one embodiment, the state-change material is spin coated or placed over a entire digital recording medium, and the material is selected such that it does not affect the read of nominal digital data indicia, but just special digital data indicia. Different spin coat speeds may be used at points in the spin coating (such as, for example, Application 600 RPM, Dwell at 2000 RPM, and Spin Off 5000 RPM). The special digital data indicia may differ in structure from other digital data indicia (e.g. a pit of different dimensions and/or shape and/or fabrication) on the digital recording medium or such special digital data indicia may be associated with one or more materials not found in respect of the other digital data indicia, or may be missing one or more materials that are associated with other digital data indicia (i.e., but not the special digital data indicia). For example, the special digital data indicia may not be associated with an oxidation scavenger that is associated with other digital data indicia associated with the state-change material. Such oxidation scavenger may cause rapid conversion of the state-change material back to its original state, while the lack of such oxidation scavenger may cause the state-change material to stay in the activated state permanently or for significant periods of time. The state-change material may change in a way to allow all of the nominal digital data indicia to be read on the digital medium except for those special digital data indicia (which may be “read-blocking digital data indicia” that is indicia that is blocking read of the medium on a reader) that, although they may be of the same structure as other nominal digital data indicia, lack one or more materials in their milieu necessary for the appropriate state change in the state-change material or necessary to keep the activated state change for a desired period of time. Thus with respect to special digital data indicia, there is not the need for engineered sub-structures (non-nominal digital data indicia) on the digital recording medium to effectuate such embodiment.

Application of the state-change material to the recording medium may be by one or more of the methods known in the art for applying materials. For example, without limitation, a state-change material comprising an azo-based dye might be spin coated or hard coated in the presence of acidic coatings over the laser incident side of an optical disc. There may be sonobleaching of the azo dye, the rate of bleaching determined by the acidity and orthosubstitution. The azo dye may be placed for example in a spin coating solution comprising 7.5 grams of dye, 10 ml of HEMA, 3.3 g of salicylic acid, 490 ml of methoxy propanol, and then filtered through a 0.2 micrometer filter. The coating may be sonobleached using a 300 kHz emitter.

The state-change material alternatively (or in combination with spin coating, or placement on one of the surfaces of the recording medium) may be included in the proper of the digital recording medium. For example, a recording dye may be mixed into the polycarbonate pellets that will be used to fabricate the digital recording medium.

The state-change material, such as a quantum dye, could be placed in association with all or substantially all of the digital data indicia on the digital recording medium. The state-change material can be selected such that in association with such indicia that the digital recording medium can not be read, but upon activation the state change allows read of the digital recording medium.

The state-change material may be, without limitation, a recording dye, such as a write-once dye, that may be activated by any of a number of wavelengths including, CD, DVD holographic, blueray and HD-DVD wavelengths. The state-change material may affect, for example, the reflection or refraction in an optical medium.

In one application, the recording medium is placed into a packaging through which sufficient energy of the appropriate type may be transmitted to allow for the desired change of the state-change material associated with the data indicia. Upon activation of the material, the data indicia read is changed in a manner (error-to-valid, valid-to-valid, valid-to-error, error-to-error, unreadable-to-readable, or vice versa) that is necessary, given software control or error correction algorithms in place to allow for the read of the medium or firmware/hardware set up, in a more robust manner or fully. When a recording medium is housed in packaging, an advantageous method of activation may be ultrasound or electromagnetic waves that pass through the packaging. For example, ultrasound (e.g. 300 kHz emitter) could be used to bleach a read-blocking dye by converting the color of the dye. By selectively activating the recording medium at a check out position with the correct activating wave, the initially unreadable recording medium can become readable. Activation of the state-change material may involve single or multiple wavelengths, sound waves, etc. Activation is not limited to player frequencies. Activation may, for example, make a disc in the error state to a disc in the valid state that plays correctly.

It may be desired for retail sale purposes of such digital recording medium that the activation be permanent and non-reversible.

In one embodiment, the state-change material is a state-change material that is light-activated or sound-activated. Examples of optical state-change materials are found for example in commonly assigned U.S. Publication No. 2004/0004922 A1. Sound-activated state-change materials are also known in the art. For example, fluorinated amphiphiles as in U.S. Pat. No. 6,028,066 (pro-chemical activated by ultrasound). Ultrasound-induced changes in material chemistry is a well-advanced area of chemical modification (See, e.g., Suslick, K. S. and Price, G. J., Applications of Ultrasound to Material Chemistry, Annu. Rev. Mater. Sci. 1999, 29: 295-326). For example, ultrasound has been shown to bean effective way to degrade azo dyes (color decay—See, e.g., Ince, N. H. and Tezcanli-Guyer, G. Ultrasonics, Apr. 1-9, 2004. 591-596). The common CD-R and DVD-R recording dyes, cyanine and phthalocyanine are two members of the azo dye family that are reactive to ultrasonic degradation.

It may be advantageous that the digital recording medium not be activated in sunlight, require only a minimum activation time (preferably less than one minute), allow for activation of multiple/stacked/layered discs at one time, and allow for activation through the case housing the digital recording medium. It may be advantageous if the activation system add little to packaging costs, have no or very little impact on long term performance of the digital recording medium, and provide manufacturing to retail end point protection. To aid in protection against piracy, it may be preferred that the recording medium be not easily reverse engineered (e.g. difficult to reproduce the chemistry of the state-change material, or placement of the same). Activation should be simple and reliable in a retail setting if activation is performed at such a juncture. In a useful retail case, the digital recording medium is not activated in the supply chain until retail sale, and the activation mechanism at check out would be difficult to detect or reverse engineer.

When special or non-nominal digital data indicia are employed on the recording medium, as such may be unique, the special or non-nominal digital data indicia may be used for track and tracing, and authentication of a digital recording medium, and therefore may be used in lieu of RFID and other such tags.

The state-change material or the special or non-nominal digital data indicia may be specifically placed. For example, when non-nominal pits are used, they may be placed at the lead area to aid in concentrating and focusing waves to the activation area. The state-change material may be placed during or after the manufacture of the recording medium. For example, the state-change material may be paced over the molded parts before metallization and bonding or added to the digital recording in the sputter coating during the manufacturing of the digital recording medium.

The recording medium may be, for example, an optical disc (such as CD, DVD, DVD-R, HD-DVD, Blu-Ray), magnetic tape, floppy discs, etc. The recording medium may store data in digital and/or analog form.

The activation mechanism may include design elements that permit the activating energy to pass through the case. A series of discrete wavelengths or sound waves may be required for activation. Activation may also be by way of passage through an electrical field generated by the activation device.

Activation may be at any point in the distribution or manufacturing chain, such as at retail sale, or may be by activation post distribution such as at home. For example, activation may be by way of entering into a website to determine a pass code or other information necessary to activate the digital recording medium. Likewise, activation may be by way of website entered into at any point in the distribution or manufacturing chain.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

What is claimed is:

1. A piracy-protected recording medium comprising:
a data portion comprising indicia readable by a recording medium reader as data;
said indicia comprising a nominal indicia portion and a special indicia portion;
a state change material, placed over entire digital recording medium, and capable of having at least a first and a second state, and selected and configured such that the state of said state change material effects the read of said special indicia portion, in a specified way, but does not effect the read of said nominal indicia portion.

2. The piracy-protected recording medium, in accordance with claim 1, where said nominal indicia portion and said special indicia portion differs in structure.

3. The piracy-protected recording medium, in accordance with claim 1, wherein said state change material is chosen, in association with said special indicia portion, to transition from said first state to said second state by exposure to activation energy.

4. The piracy-protected recording medium, in accordance with claim 1, wherein said state change material is chosen, in association with said special indicia portion, to transition from said second state to said first state spontaneously at a prescribed time duration after activation.

5. The piracy-protected recording medium, in accordance with claim 1, wherein composition of material associated with said nominal indicia portion differs from that associated with composition of material associated with said special indicia portion.

6. The piracy-protected recording medium, in accordance with claim 5, wherein an oxidation scavenger is associated with said nominal indicia portion and not associated with said special indicia portion.

7. A piracy-protected recording medium comprising:
a substrate molded so as to have a first major surface with information pits and information lands thereon and a second major surface that is relatively planar;
a first optical state change security material, applied to at least a first portion of said substrate, and capable of converting from a first optical state to a second optical state upon application of energy at a first set of one or more wavelengths; and
a second optical state change security material, applied to at least a second portion of said substrate, and capable of converting from a third optical state to a fourth optical state upon application of energy at a second set of one or more wavelengths.

8. The piracy-protected recording medium, in accordance with claim 7, wherein said energy is chosen from the group consisting of acoustical energy, thermal energy, mechanical energy, electro-magnetic energy, radio frequency energy, and optical energy.
